(19) United States
(12) Patent Application Publication
(10) Pub. No.: US 2018/0314231 A1
(43) Pub. Date: Nov. 1, 2018

(54) METHOD AND SYSTEM FOR PREDICTING DAMAGE OF POTENTIAL INPUT TO INDUSTRIAL PROCESS

(71) Applicant: Honeywell International Inc., Morris Plains, NJ (US)

(72) Inventor: Sridhar Srinivasan, Houston, TX (US)

(21) Appl. No.: 15/583,728

(22) Filed: May 1, 2017

(51) Int. Cl. G05B 19/4065; G06N 5/02

(52) U.S. Cl. CPC G05B 19/4065; G05B 2219/42155; G06N 5/022

(57) ABSTRACT

A method for damage prediction includes obtaining a damage prediction model for equipment used in an industrial process, where the damage prediction model mathematically represents expected damage to the equipment based on a plurality of characteristics of a process input and a plurality of characteristics of the equipment. The method also includes obtaining actual values for the plurality of characteristics of the process input. The method further includes determining a predicted rate of damage to the equipment by the process input based on the actual values for the plurality of characteristics of the process input, the plurality of characteristics of the equipment, and the damage prediction model. The method additionally includes generating an indication of a safety level of the process input for the equipment and displaying the indication of the safety level of the process input for the equipment.

### TECHNICAL FIELD

This disclosure relates generally to industrial process control and automation systems. More specifically, this disclosure relates to a method and system for predicting damage of a potential input to an industrial process.

### BACKGROUND

Industrial processes often cause “wear and tear” on process equipment in industrial facilities, which may be referred to as damage or corrosion. One factor that affects the amount of damage caused to process equipment is the choice of process inputs, which refers to the materials that are provided to the process equipment. Typically, a small number of parameters are considered when selecting process inputs. These are usually parameters that are known to have some impact on damage rates to process equipment. However, the selection is usually made based on an industry standard or a best estimate of how much damage the process inputs will cause based on the parameters.

### SUMMARY

This disclosure provides a method and system for predicting damage of a potential input to an industrial process.

In a first embodiment, a method for damage prediction includes obtaining a damage prediction model for equipment used in an industrial process, where the damage prediction model mathematically represents expected damage to the equipment based on a plurality of characteristics of a process input and a plurality of characteristics of the equipment. The method also includes obtaining actual values for the plurality of characteristics of the process input. The method further includes determining a predicted rate of damage to the equipment by the process input based on the actual values for the plurality of characteristics of the process input, the plurality of characteristics of the equipment, and the damage prediction model. The method additionally includes generating an indication of a safety level of the process input for the equipment and displaying the indication of the safety level of the process input for the equipment.

In a second embodiment, an apparatus for real-time damage prediction includes at least one memory configured to store actual values for a plurality of characteristics of a process input and a damage prediction model for equipment used in an industrial process. The damage prediction model mathematically represents expected damage to the equipment based on the plurality of characteristics of the process input and a plurality of characteristics of the equipment. The apparatus also includes at least one processing device configured to determine a predicted rate of damage to the equipment by the process input based on the actual values for the plurality of characteristics of the process input, the plurality of characteristics of the equipment, and the damage prediction model. The at least one processing device is also configured to generate an indication of a safety level of the process input for the equipment and display the indication of the safety level of the process input for the equipment.

In a third embodiment, a non-transitory computer readable medium contains computer readable program code that when executed causes at least one processing device to obtain a damage prediction model for equipment used in an industrial process. The damage prediction model mathematically represents expected damage to the equipment based on a plurality of characteristics of a process input and a plurality of characteristics of the equipment. The medium also contains computer readable program code that when executed causes the at least one processing device to obtain actual values for the plurality of characteristics of the process input. The medium further contains computer readable program code that when executed causes the at least one processing device to determine a predicted rate of damage to the equipment by the process input based on the actual values for the plurality of characteristics of the process input, the plurality of characteristics of the equipment, and the damage prediction model. The medium also contains computer readable program code that when executed causes the at least one processing device to generate an indication of a safety level of the process input for the equipment and display the indication of the safety level of the process input for the equipment.

Other technical features may be readily apparent to one skilled in the art from the following figures, descriptions, and claims.

### BRIEF DESCRIPTION OF THE DRAWINGS

For a more complete understanding of this disclosure and its advantages, reference is now made to the following description, taken in conjunction with the accompanying drawings, in which:

FIG. 1 illustrates an example industrial process control and automation system according to this disclosure;

FIG. 2 illustrates an example device for damage prediction according to this disclosure;

FIG. 3 illustrates an example graphical user interface (GUI) for displaying and collecting input data for a damage prediction system according to this disclosure;

FIG. 4 illustrates an example GUI for displaying output data for a damage prediction system according to this disclosure;

FIG. 5 illustrates an example method for damage prediction according to this disclosure; and

FIG. 6 illustrates an example graph of results obtained using damage rate prediction according to this disclosure.

### DETAILED DESCRIPTION

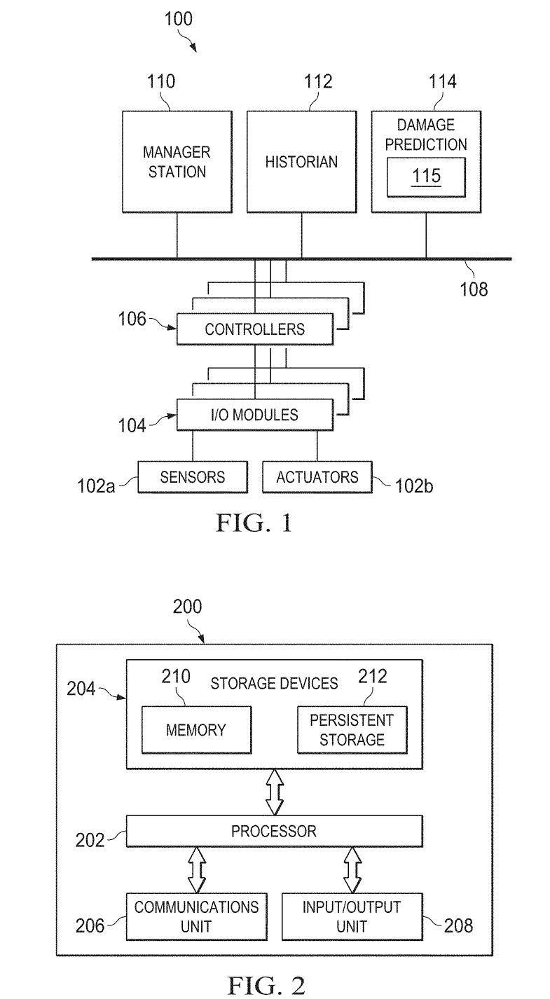

FIGS. 1 through 6, discussed below, and the various embodiments used to describe the principles of the present invention in this patent document are by way of illustration only and should not be construed in any way to limit the scope of the invention. Those skilled in the art will understand that the principles of the invention may be implemented in any type of suitably arranged device or system.

Industrial processes often cause “wear and tear” on process equipment in industrial facilities. The amount of wear and tear, which may also be referred to as damage or corrosion, may vary depending on the quality of inputs selected for an industrial process. For example, different qualities of crude oil may cause different amounts of damage to process equipment during operation. Accordingly, predicting the amount of damage caused by different crude blends can be useful or important in selecting crude blends to process in order to prevent dangerous or costly failures in industrial facilities.

Typically, parameters of process inputs are used by an owner or operator of an industrial facility to determine whether or not to use a particular process input in the facility. For example, in a facility that processes crude oil, the total acid number (TAN) and sulfur content of a crude blend may be used to determine whether or not to use the crude blend in the facility. However, the relationship of TAN and sulfur content to damage varies depending on the characteristics of the process equipment in a given facility. Accordingly, if the owner or operator of the facility is selecting crude blends for a facility based only on the TAN and sulfur content, only an educated guess can be made as to whether the crude blend will cause unacceptable damage to the process equipment in that facility.

This disclosure provides techniques for damage prediction that allow, among other things, facility owners or operators to predict the amount of damage to equipment that a particular process input may cause before using that process input in a facility. For example, these techniques can be used to provide a definitive, quantifiable basis to correlate (i) crude TAN and sulfur content and (ii) rates of damage to particular process equipment for specific blends of crude oil. Once a model is used to generate a prediction of a rate of damage, the prediction can be presented to an owner or operator of an industrial facility, and the owner or operator may use the prediction to determine whether to use a process input in a specific system.

These techniques can therefore be used to avoid purchasing process inputs that would cause unacceptable amounts of damage to process equipment. This helps to increase the operational lifetime of the process equipment while reducing the risk of injury and unnecessary repair expenses. These techniques can also be used to locate process inputs that are considered by other metrics (such as raw TAN and sulfur content) to be too damaging for use and that are accordingly priced inexpensively but which are determined by the techniques of this disclosure to be safe for use. This helps to increase the purchasing efficiency of the owner or operator.

FIG. 1 illustrates an example industrial process control and automation system 100 according to this disclosure. As shown in FIG. 1, the system 100 includes various components that facilitate production or processing of at least one product or other material. For instance, the system 100 can be used to facilitate control or monitoring of components in one or multiple industrial plants. Each plant represents one or more processing facilities (or one or more portions thereof), such as one or more manufacturing facilities for producing at least one product or other material. In general, each plant may implement one or more industrial processes and can individually or collectively be referred to as a process system. A process system generally represents any system or portion thereof configured to process one or more products or other materials in some manner

In the example shown in FIG. 1, the system 100 includes one or more sensors 102a and one or more actuators 102b. The sensors 102a and actuators 102b represent components in a process system that may perform any of a wide variety of functions. For example, the sensors 102a could measure a wide variety of characteristics in the process system, such as temperature, pressure, or flow rate. Also, the actuators 102b could alter a wide variety of characteristics in the process system. Each of the sensors 102a includes any suitable structure for measuring one or more characteristics in a process system. Each of the actuators 102b includes any suitable structure for operating on or affecting one or more conditions in a process system.

At least one input/output (I/O) module 104 is coupled to the sensors 102a and actuators 102b. The I/O modules 104 facilitate interaction with the sensors 102a, actuators 102b, or other field devices. For example, an I/O module 104 could be used to receive one or more analog inputs (AIs), digital inputs (DIs), digital input sequences of events (DISOEs), or pulse accumulator inputs (PIs) or to provide one or more analog outputs (AOs) or digital outputs (DOs). Each I/O module 104 includes any suitable structure(s) for receiving one or more input signals from or providing one or more output signals to one or more field devices. Depending on the implementation, an I/O module 104 could include fixed number(s) and type(s) of inputs or outputs or reconfigurable inputs or outputs.

The system 100 also includes various controllers 106. The controllers 106 can be used in the system 100 to perform various functions in order to control one or more industrial processes. For example, a first set of controllers 106 may use measurements from one or more sensors 102a to control the operation of one or more actuators 102b. These controllers 106 could interact with the sensors 102a, actuators 102b, and other field devices via the I/O module(s) 104. A second set of controllers 106 could be used to optimize the control logic or other operations performed by the first set of controllers. A third set of controllers 106 could be used to perform additional functions.

Each controller 106 includes any suitable structure for controlling one or more aspects of an industrial process. At least some of the controllers 106 could, for example, represent proportional-integral-derivative (PID) controllers or multivariable controllers, such as Robust Multivariable Predictive Control Technology (RMPCT) controllers or other types of controllers implementing model predictive control (MPC) or other advanced predictive control. As a particular example, each controller 106 could represent a computing device running a real-time operating system, a MICROSOFT WINDOWS operating system, or other operating system.

Owners or operators may access manager stations 110 in order to monitor processes and evaluate policy changes, evaluate purchases of new process inputs, and take any other appropriate action. Each manager station 110 could be used to provide information to a manager and receive information from a manager. For example, each manager station 110 could provide information identifying a current or historical state of an industrial process, such as values of various process variables and warnings, alarms, predicted damage rates, or other states associated with an industrial process. Each manager station 110 could also receive information on the status of plant components, such as piping. Each manager station 110 includes any suitable structure for displaying information to and interacting with a user, such as a computing device running a MICROSOFT WINDOWS operating system or other operating system.

A process data historian 112 is coupled to the network 108 in this example. The historian 112 could represent a component that stores various information about the system 100. The historian 112 could, for example, store information used during process control, production scheduling, and optimization. The historian 112 represents any suitable structure for storing and facilitating retrieval of information. Although shown as a single centralized component coupled to the network 108, the historian 112 could be located elsewhere in the system 100, or multiple historians could be distributed in different locations in the system 100. Moreover, in other embodiments, one or more historians 112 may be external to and communicatively coupled to the system 100.

The system 100 also includes a damage prediction system 114, which is coupled to the network 108 in this example. The prediction system 114 communicates with the historian 112 and other components of the system 100, such as via the network 108, in order to receive data related to operation of the system 100 and the underlying industrial process(es). Based on that data, the prediction system 114 generates one or more predictions of damage to process equipment implementing the underlying industrial process(es) based on the characteristics of potential process inputs. For example, the prediction system 114 could generate predicted rates of damage and identify predicted failures of process equipment based on those rates.

The prediction system 114 includes at least one damage prediction model 115. Each damage prediction model 115 mathematically represents how damage mechanisms affect process equipment. The model 115 is used, along with process data, characteristics of potential process inputs, and characteristics of the process equipment, to predict how damage would likely occur in the process equipment as a result of using the process inputs. In some embodiments, the prediction system 114 performs a sensitivity analysis using the model 115 and a range of values of the process data, characteristics of potential process inputs, and characteristics of the process equipment to perform this damage prediction.

The prediction system 114 could then communicate predicted damage information to the manager stations 110 or other destinations for use in determining whether new process inputs would be safe for use in an industrial facility controlled by the system 100. As a particular example, managers could use the predicted damage information to determine whether a particular blend of crude oil would cause damage at an unacceptable rate to process equipment in the facility. In some embodiments, the damage rates predicted by the prediction system 114 can be compared to multiple thresholds that represent different levels of risk. For instance, a safe threshold could be predetermined such that operation of process equipment below the safe threshold is considered low or no risk. Similarly, an unacceptable threshold could be predetermined such that operation of process equipment above the unacceptable threshold is considered unacceptably risky. In this example, operation of the process equipment between these two thresholds is considered an acceptable risk.

Additional details regarding the operations of the prediction system 114 are provided below. The prediction system 114 could be implemented in any suitable manner For example, the prediction system 114 could be implemented using software or firmware instructions that are executed by one or more processors of a computing device, such as a desktop, laptop, server, or tablet computer. The prediction system 114 could also be implemented in other parts of the system 100 and need not represent a stand-alone component, such as when executed by one or more of the manager stations 110 or controllers 106. The prediction system 114 could further be implemented outside of the system 100, such as in a remote server, a cloud-based environment, or any other computing system or environment communicatively coupled to the system 100. Note, however, that the prediction system 114 could be implemented in any other suitable manner

Although FIG. 1 illustrates one example of an industrial process control and automation system 100, various changes may be made to FIG. 1. For example, the system 100 could include any number of sensors, actuators, controllers, networks, manager stations, historians, prediction systems, and other components. Also, the makeup and arrangement of the system 100 in FIG. 1 is for illustration only. Components could be added, omitted, combined, further subdivided, or placed in any other suitable configuration according to particular needs. Further, particular functions have been described as being performed by particular components of the system 100. This is for illustration only. In general, control and automation systems are highly configurable and can be configured in any suitable manner according to particular needs. In addition, while FIG. 1 illustrates one example operational environment where damage prediction can be used, this functionality can be used in any other suitable system.

FIG. 2 illustrates an example device 200 for damage prediction according to this disclosure. The device 200 could, for example, denote a computing device that executes the prediction system 114. Note, however, that each prediction system could be implemented using any other suitable device.

As shown in FIG. 2, the device 200 includes at least one processor 202, at least one storage device 204, at least one communications unit 206, and at least one input/output (I/O) unit 208. Each processor 202 can execute instructions, such as those that may be loaded into a memory 210. Each processor 202 denotes any suitable processing device, such as one or more microprocessors, microcontrollers, digital signal processors, application specific integrated circuits (ASICs), field programmable gate arrays (FPGAs), or discrete circuitry.

The memory 210 and a persistent storage 212 are examples of storage devices 204, which represent any structure(s) capable of storing and facilitating retrieval of information (such as data, program code, and/or other suitable information on a temporary or permanent basis). The memory 210 may represent a random access memory, buffer, cache, or any other suitable volatile or non-volatile storage device(s). The persistent storage 212 may contain one or more components or devices supporting longer-term storage of data, such as a read only memory, hard drive, Flash memory, or optical disc.

The communications unit 206 supports communications with other systems or devices. For example, the communications unit 206 could include at least one network interface card or wireless transceiver facilitating communications over at least one wired or wireless network, such as the network 108. The communications unit 206 may support communications through any suitable physical or wireless communication link(s).

The I/O unit 208 allows for input and output of data. In other embodiments, the I/O unit 208 may provide a connection for user input through a keyboard, mouse, keypad, touchscreen, or other suitable input device. The I/O unit 208 may also send output to a display, printer, or other suitable output device. The user input and output devices may, for example, be included in the manager station 110.

Although FIG. 2 illustrates one example of a device 200 for damage prediction, various changes may be made to FIG. 2. For example, various components in FIG. 2 could be combined, further subdivided, rearranged, or omitted and additional components could be added according to particular needs. Also, computing devices come in a wide variety of configurations, and FIG. 2 does not limit this disclosure to any particular configuration of computing device.

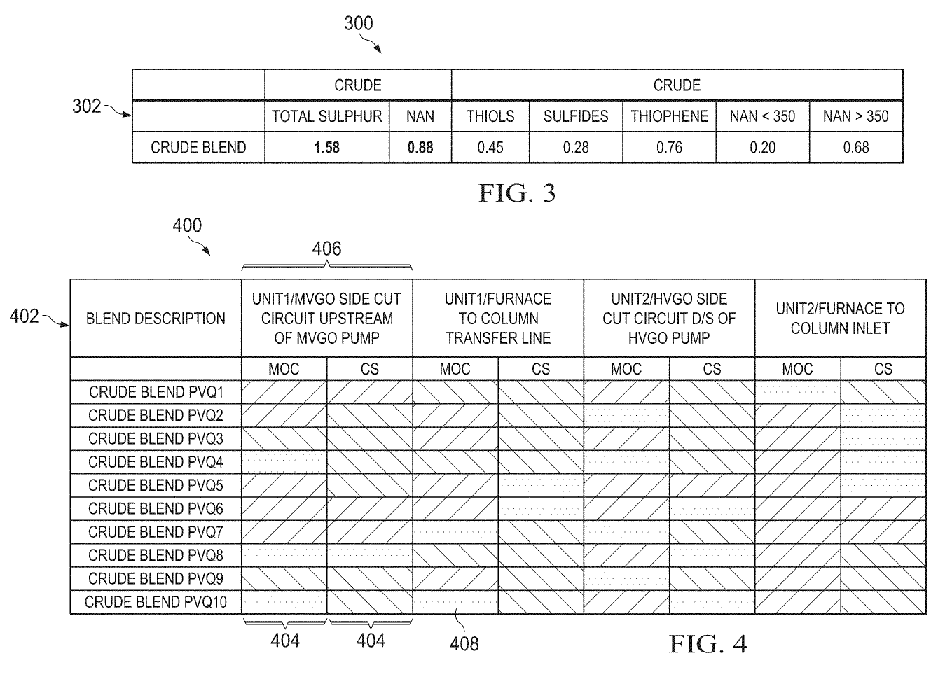

FIG. 3 illustrates an example graphical user interface (GUI) 300 for displaying and collecting input data for a damage prediction system according to this disclosure. The GUI 300 could, for example, be presented by the device 200 (such as one implementing a manager station 110) to an owner or operator of an industrial facility. As a particular example, the GUI 300 could be generated by software executed by the device 200. Note, however, that the GUI 300 could be displayed on any other suitable display device and could be implemented using any other suitable computing device.

The GUI 300 here can be used to allow an owner or operator of an industrial facility to input characteristics of a process input, such as a crude oil blend, for evaluation by the damage prediction system 114. The damage prediction system 114 may use a prediction model 115 to make its evaluation using the characteristics of the process input. In this example, the GUI 300 displays characteristics 302 of a crude oil blend composed of two fractions of crude oil. These characteristics include total sulfur content, naphthenic acid number (NAN) which is derived from the Total Acid Number (TAN), thiol content, sulfide content, and thiophene content. The naphthenic acid content represented by the NAN is further broken down into two components: the fraction of the NAN that has a molecular weight less than or equal to 350 and the fraction of the NAN that has a molecular weight greater than 350. It is understood that other or additional characteristics may be included in other embodiments. It is also understood that the GUI 300 could be expanded, such as by adding additional rows, to allow for entry of characteristics of multiple potential process inputs.

Although FIG. 3 illustrates one example of a GUI 300 for displaying and collecting input data for a damage prediction system, various changes may be made to FIG. 3. For example, the content, layout, and arrangement of the GUI 300 are for illustration only, and various changes may be made to the GUI as needed or desired.

FIG. 4 illustrates an example GUI 400 for displaying output data for a damage prediction system according to this disclosure. The GUI 400 could, for example, be presented by the device 200 (such as one implementing a manager station 110) to an owner or operator of an industrial facility. As a particular example, the GUI 400 could be generated by software executed by the device 200. Note, however, that the GUI 400 could be displayed on any other suitable display device and could be implemented using any other suitable computing device.

The GUI 400 can be used here to allow an owner or operator of an industrial facility to evaluate the predicted damage to process equipment that could be caused by one or more process inputs, such as crude oil blends. In FIG. 4, each row 402 can display predicted damage information for a particular process input (such as a crude oil blend) for multiple pieces of process equipment. The GUI 400 here is divided up into columns 404 that represent individual pieces of process equipment, and the columns 404 can be grouped into groups 406 of columns for each process unit in the facility. Individual cells 408 represent predicted damage information for a particular piece of process equipment and a particular process input.

The predicted damage information displayed in the GUI 400 may correspond, for example, to input characteristics from the GUI 300 of FIG. 3. In this example, information corresponding to a predicted rate of damage for ten different crude blends as used in four different pieces of process equipment is displayed. In this example, the predicted rate of damage information for each piece of equipment includes the predicted rate of damage for the material of construction (MOC) of the currently installed process equipment and a comparative predicted rate of damage for carbon steel (CS). This is provided, for example, as a basis to assess whether CS represents a viable material option for a future replacement of the process equipment. Each cell 408 of the GUI 400 displays color-coded, shaded, or other graphical information that represents predicted damage rates. This allows for a quick assessment of the safety level of the different crude oil blends for use in the different pieces of process equipment.

In this example, predicted damage rates for crude blends are classified into three categories, which could be assigned different colors for display in the GUI 400. One color (such as green) can be used to indicate that use of the crude blend in the process equipment is safe or carries low risk (such as when the predicted damage rate is below a predetermined safe threshold). A second color (such as yellow) can be used to indicate that use of the crude blend in the process equipment carries an acceptable risk (such as when the predicted damage rate is above a predetermined safe threshold but below a predetermined unacceptable threshold). A third color (such as red) can be used to indicate that use of the crude blend in the process equipment is unsafe, or carries an unacceptable risk (such as when the predicted damage rate is above a predetermined unacceptable threshold). Other categories could also be used, such as different shading patterns.

Although FIG. 4 illustrates one example of a GUI for displaying output data for a damage prediction system, various changes may be made to FIG. 4. For example, the content, layout, and arrangement of the GUI are for illustration only, and various changes may be made to the GUI as needed or desired.

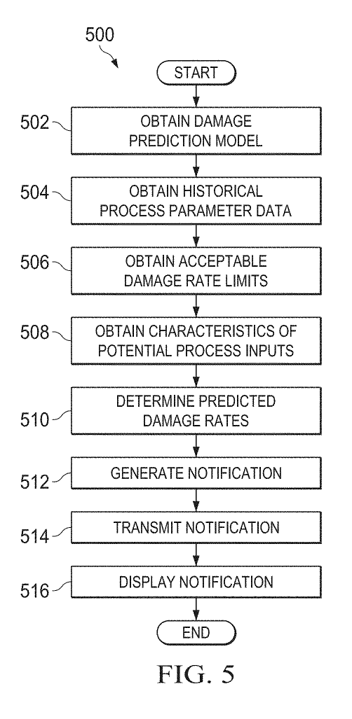

FIG. 5 illustrates an example method 500 for damage prediction according to this disclosure. For ease of explanation, the method 500 is described as being executed by the device 200 of FIG. 2 to implement the damage prediction system 114, although any other suitable device could be used to implement the method 500. For simplicity, the method 500 is described with respect to one potential process input and one piece of process equipment, although it should be understood that the method 500 may be performed for any number of potential process inputs or pieces of process equipment.

At step 502, a damage prediction model, such as model 115, is obtained. This could include, for example, the prediction system 114 obtaining the model 115 from any suitable source. In some embodiments, different prediction models may be associated with different damage mechanisms, such as sour water damage, amine damage, crude oil damage, sulfuric acid alkylation, component cracking, or the like. Also, in some embodiments, a prediction model could denote a plant-wide model that includes separate damage prediction models for each specific piece of process equipment of a plant, and the method 500 could be performed for each specific piece of process equipment using its corresponding damage prediction model in such a case. Each prediction model could be generated in any suitable manner, such as based on actual damage detected during physical inspections of plant components over time.

At step 504, historical process parameter data is obtained. This could include, for example, the prediction system 114 obtaining historical process parameter data from the historian 112. The historical process parameter data may be recorded in the historian 112 and accessed by the prediction system 114 as needed. The process parameters may include any suitable parameters related to an industrial process, such as chemical mixture ratios, temperatures, pressures, flow rates, vibrations, or the like. In some embodiments, the historical process parameter data includes data collected from offline inspections and from real-time sensors. Also, in some embodiments, this parameter data may be used to update the damage prediction model 115 for more accurate prediction of damage rates.

At step 506, acceptable limits for damage rates of one or more pieces of process equipment are obtained. This could include, for example, the prediction system 114 retrieving the acceptable limits from memory or receiving the acceptable limits as an input, such as from a user at a manager station 110. In some embodiments, multiple acceptable limits can be obtained, which may represent thresholds for various operation scenarios. Example operation scenarios can include unacceptable operation scenarios (scenarios in which operation carries an unacceptably high risk of damage), acceptable operation scenarios (scenarios in which operation carries an acceptable risk of damage), and desirable operation scenarios (scenarios in which operation carries low or no risk of damage).

At step 508, characteristics of potential process inputs are obtained. In some embodiments, these characteristics are obtained using the GUI 300 of FIG. 3 that is displayed on a station 110. In such embodiments, an owner or operator may input the characteristics into the GUI 300 for use by the prediction system 114.

At step 510, predicted damage is determined for one or more pieces of process equipment. This could include, for example, the prediction system 114 determining predicted damage rates for one or more pieces of process equipment based on the damage prediction model 115 by applying the characteristics of the potential process input to the model 115.

At step 512, a notification of the predicted damage rates is generated. This could include, for example, the prediction system 114 generating the notification based on a comparison between the predicted real-time damage rate and the acceptable damage rate limits established earlier. The resulting comparison may indicate acceptable or unacceptable damage rates. In embodiments with multiple damage rate limits (such as safe, acceptable, and unacceptable limits), the resulting comparison may indicate one of at least three levels of acceptability (such as unacceptable, acceptable, and safe).

At step 514, the predicted damage rates and notifications are transmitted to one or more owners or operators. In some embodiments, this includes converting the raw damage rate information into a representative indication (such as a color or shading code) of the damage rates. For example, a damage rate below 41 mils per year (mpy) could be considered safe and could be assigned a green color code, a damage rate between 41 and 43 mpy could be considered acceptable and assigned a yellow color code, and a damage rate above 43 mpy could be considered unacceptable and assigned a red color code. Transmitting the notification to one or more owners or operators could include, for example, the prediction system 114 transmitting the data to a manager station 110 for display to one or more owners or operators via the GUI 400 of FIG. 4. In some embodiments, the transmitted data is also stored in a process data historian, such as historian 112.

In this way, the predicted damage rates allow management to select process inputs to reduce potential damage. Additionally, the predicted damage rates allow management to locate process inputs that are safe for use in a facility but that are priced lower than other inputs due to, for example, a perceived risk of damage based on characteristics of the process inputs in question.

At step 516, the transmitted damage rate predictions are displayed, such as by a manager station 110. This could include, for example, displaying the GUI 400 of FIG. 4 to a user. In some embodiments, the notifications may be the color-coded, shaded, or other portions of the GUI 400, and the raw damage rate prediction data may not be displayed. In other embodiments, the raw damage rate prediction data may be displayed with the color-coded, shaded, or other information overlaid on the raw data.

Note that the method 500 or portions of the method 500 could be repeated any number of times and at any suitable intervals to provide damage prediction for one or multiple pieces of process equipment. This allows owners and operators of industrial control and automation systems to more accurately gauge potential damage to their systems by potential process inputs and to acquire process inputs suitable for use with their equipment.

Although FIG. 5 illustrates one example of a method 500 for damage prediction, various changes may be made to FIG. 5. For example, while shown as a series of steps, various steps in FIG. 5 could overlap, occur in parallel, occur in a different order, or occur any number of times.

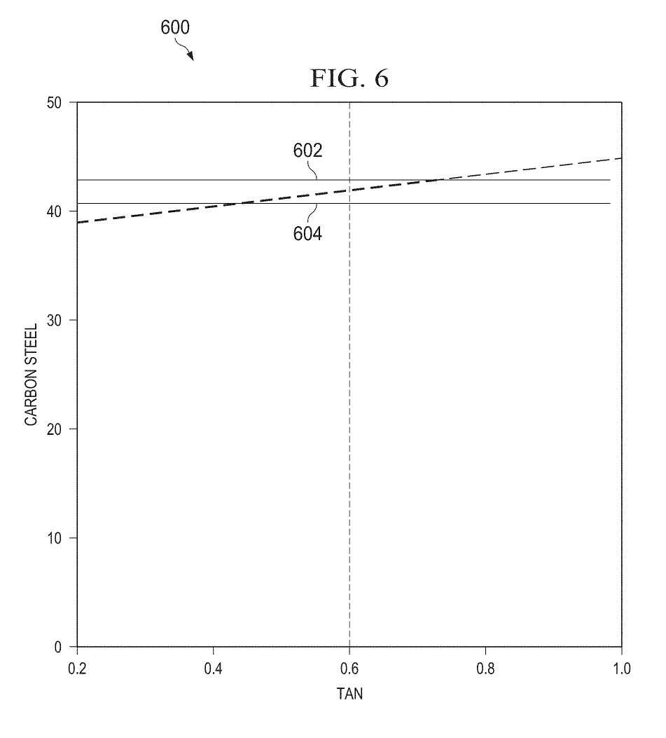

FIG. 6 illustrates an example graph 600 of results obtained using damage rate prediction according to this disclosure. The example in FIG. 6 shows analysis of damage rates due to TAN and sulfidic corrosion. This example may represent the result obtained by an embodiment of a damage prediction system 114 and the damage prediction model 115.

In the example of FIG. 6, a process input is being selected for use with a four-inch internal diameter carbon steel piping section carrying a crude oil blend to a crude unit. Normal operating conditions are determined to be an 850 gpm flow rate of crude at 650° F. The piping section is expected to be replaced in five years, and the corrosion allowance is 215 mil with a minimum allowable thickness of 40 mil before replacement. This means that the piping section can theoretically sustain an average corrosion rate of 43 mpy until its replacement in five years. A corrosion rate above 43 mpy would result in unacceptable thinness of the piping section before its scheduled end of life, and accordingly 43 mpy is determined to be a threshold over which the corrosion rate is unacceptable. It may further be determined that a corrosion rate of 41 mpy or less is very low risk, and a low risk damage rate threshold may be set at 41 mpy.

The graph 600 illustrates the results of a single-variable sensitivity analysis performed on the piping section. In some embodiments, the sensitivity analysis is performed using a damage prediction model that takes into account process variables such as temperature, hydrocarbon content, flow regimes, and wall shear stress in the piping section. Variances in these parameters may occur while the process is online, and these variances can affect the rate of damage caused by the process input. Accordingly, a sensitivity analysis that is run for a range of values of both the process input characteristics and the process parameters results in a prediction of possible rates of damage that covers a large range of potential operation scenarios.

The graph 600 plots the predicted damage rates resulting from the sensitivity analysis versus the TAN characteristic of potential process inputs. Based on the graph 600, determinations may be made as to whether the TAN of a particular process input is safe for use with the piping. It is understood that the sensitivity analysis may be used for other process input characteristics such as sulfur content, and the results of such a sensitivity analysis may be used in combination with the graph 600 or separately to determine whether the process input is safe for use with the piping.

As seen in the graph 600, an acceptable damage rate threshold 602 is set at 43 mpy, and a desired damage rate threshold 604 is set at 41 mpy. The acceptable damage rate threshold 602 is exceeded when the TAN of the process input exceeds 0.74 mg/g, and the desired damage rate threshold is met when the TAN of the process input is below 0.4 mg/g.

Accordingly, the damage prediction system 114 may generate and transmit predicted damage rate information and notifications according to the method 500 that indicate process inputs with a TAN above 0.74 mg/g are unacceptably risky, process inputs with a TAN between 0.4 and 0.74 are acceptably risky, and process inputs with a TAN below 0.4 are safe. This information may be displayed to an owner or operator of the facility, such as in a GUI 400 that shows process inputs with a TAN above 0.74 mg/g as red, process inputs with a TAN between 0.4 and 0.74 as yellow, and process inputs with a TAN below 0.4 as green.

Although FIG. 6 illustrates one example of a graph 600 of results obtained using damage rate prediction, various changes may be made to FIG. 6. For example, the data shown in FIG. 6 relates to specific process equipment, and other data could relate to other process equipment.

In some embodiments, various functions described in this patent document are implemented or supported by a computer program that is formed from computer readable program code and that is embodied in a computer readable medium. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable storage device.

It may be advantageous to set forth definitions of certain words and phrases used throughout this patent document. The terms “application” and “program” refer to one or more computer programs, software components, sets of instructions, procedures, functions, objects, classes, instances, related data, or a portion thereof adapted for implementation in a suitable computer code (including source code, object code, or executable code). The term “communicate,” as well as derivatives thereof, encompasses both direct and indirect communication. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

The description in the present application should not be read as implying that any particular element, step, or function is an essential or critical element that must be included in the claim scope. The scope of patented subject matter is defined only by the allowed claims. Moreover, none of the claims invokes 35 U.S.C. § 112(f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” “processor,” or “controller” within a claim is understood and intended to refer to structures known to those skilled in the relevant art, as further modified or enhanced by the features of the claims themselves, and is not intended to invoke 35 U.S.C. § 112(f).

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A method for damage prediction, comprising:
obtaining a damage prediction model for equipment used in an industrial process, wherein the damage prediction model mathematically represents expected damage to the equipment based on a plurality of characteristics of a process input and a plurality of characteristics of the equipment;
obtaining actual values for the plurality of characteristics of the process input;
determining a predicted rate of damage to the equipment by the process input based on the actual values for the plurality of characteristics of the process input, the plurality of characteristics of the equipment, and the damage prediction model;
generating an indication of a safety level of the process input for the equipment; and
displaying the indication of the safety level of the process input for the equipment.

2. The method of claim 1, wherein obtaining the actual values for the plurality of characteristics of the process input comprises obtaining a sulfur content and a total acid number of the process input.

3. The method of claim 1, wherein determining the predicted rate of damage to the equipment comprises performing a sensitivity analysis for a range of values of the plurality of characteristics of the process input.

4. The method of claim 1, further comprising:
obtaining an indication of an acceptable rate of damage for the equipment;
wherein the indication of the safety level of the process input for the equipment is based on the predicted rate of damage to the equipment and the acceptable rate of damage for the equipment.

5. The method of claim 1, wherein:
generating the indication of the safety level of the process input for the equipment comprises assigning a color code to the process input, and
displaying the indication of the safety level of the process input for the equipment comprises displaying the color code in a graphical user interface (GUI) that relates the displayed color code to the process input and to the equipment.

6. The method of claim 4, further comprising:
obtaining an indication of a safe rate of damage for the equipment,
wherein determining the safety level of the process input for the equipment comprises determining the safety level of the process input for the equipment based on the predicted rate of damage to the equipment, the safe rate of damage for the equipment, and the acceptable rate of damage for the equipment.

7. The method of claim 1, further comprising:
displaying a graphical user interface (GUI) configured to obtain the plurality of characteristics of the process input.

8. An apparatus for damage prediction, comprising:
at least one memory configured to store actual values for a plurality of characteristics of a process input and a damage prediction model for equipment used in an industrial process, the damage prediction model mathematically representing expected damage to the equipment based on the plurality of characteristics of the process input and a plurality of characteristics of the equipment; and
at least one processing device configured to:
determine a predicted rate of damage to the equipment by the process; input based on the actual values for the plurality of characteristics of the process input, the plurality of characteristics of the equipment, and the damage prediction model;
generate an indication of a safety level of the process input for the equipment; and
display the indication of the safety level of the process input for the equipment.

9. The apparatus of claim 8, wherein the plurality of characteristics of the process input comprises a sulfur content and a total acid number of the process input.

10. The apparatus of claim 8, wherein the at least one processing device is configured to determine the predicted rate of damage to the equipment by performing a sensitivity analysis for a range of values of the plurality of characteristics of the process input.

11. The apparatus of claim 8, wherein:
the at least one processing device is further configured to obtain an indication of an acceptable rate of damage for the equipment; and
the indication of the safety level of the process input for the equipment is based on the predicted rate of damage to the equipment and the acceptable rate of damage for the equipment.

12. The apparatus of claim 8, wherein the at least one processing device is further configured to:
generate the indication of the safety level of the process input for the equipment by assigning a color code to the process input; and
display the indication of the safety level of the process input for the equipment by displaying the color code in a graphical user interface (GUI) that relates the displayed color code to the process input and to the equipment.

13. The apparatus of claim 11, wherein:
the at least one processing device is further configured to obtain an indication of a safe rate of damage for the equipment; and
the at least one processing device is configured to determine the safety level of the process input for the equipment based on the predicted rate of damage to the equipment, the safe rate of damage for the equipment, and the acceptable rate of damage for the equipment.

14. The apparatus of claim 8, wherein the at least one processing device is further configured to display a graphical user interface (GUI) configured to obtain the plurality of characteristics of the process input.

15. A non-transitory computer readable medium containing computer readable program code that when executed causes at least one processing device to:
obtain a damage prediction model for equipment used in an industrial process, wherein the damage prediction model mathematically represents expected damage to the equipment based on a plurality of characteristics of a process input and a plurality of characteristics of the equipment;
obtain actual values for the plurality of characteristics of the process input;
determine a predicted rate of damage to the equipment by the process input based on the actual values for the plurality of characteristics of the process input, the plurality of characteristics of the equipment, and the damage prediction model;
generate an indication of a safety level of the process input for the equipment; and
display the indication of the safety level of the process input for the equipment.

16. The non-transitory computer readable medium of claim 15, wherein the plurality of characteristics of the process input comprises a sulfur content and a total acid number of the process input.

17. The non-transitory computer readable medium of claim 15, wherein the computer readable program code that when executed causes the at least one processing device to determine the predicted rate of damage to the equipment comprises:
computer readable program code that when executed causes the at least one processing device to perform a sensitivity analysis for a range of values of the plurality of characteristics of the process input.

18. The non-transitory computer readable medium of claim 15, further containing computer readable program code that when executed causes the at least one processing device to obtain an indication of an acceptable rate of damage for the equipment;
wherein the indication of the safety level of the process input for the equipment is based on the predicted rate of damage to the equipment and the acceptable rate of damage for the equipment.

19. The non-transitory computer readable medium of claim 15, further containing computer readable program code that when executed causes the at least one processing device to:
generate the indication of the safety level of the process input for the equipment by assigning a color code to the process input; and
display the indication of the safety level of the process input for the equipment by displaying the color code in a graphical user interface (GUI) that relates the displayed color code to the process input and to the equipment.

20. The non-transitory computer readable medium of claim 18, further containing computer readable program code that when executed causes the at least one processing device to obtain an indication of a safe rate of damage for the equipment;
wherein the computer readable program code that when executed causes the at least one processing device to determine the safety level of the process input comprises computer readable program code that when executed causes the at least one processing device to:
determine the safety level of the process input for the equipment comprises determining the safety level of the process input for the equipment based on the predicted rate of damage to the equipment, the safe rate of damage for the equipment, and the acceptable rate of damage for the equipment.
